(19) United States
(12) Patent Application Publication
(10) Pub. No.: US 2010/0088598 A1
(43) Pub. Date: Apr. 8, 2010

(54) FUNCTION EXECUTION METHOD AND MOBILE TERMINAL OPERATING WITH THE SAME

(75) Inventors: Bong Won LEE, Seoul (KR); In Won JONG, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/572,219

(22) Filed: Oct. 1, 2009

(30) Foreign Application Priority Data
Oct. 2, 2008 (KR) 10-2008-0097347

(51) Int. Cl. G06F 3/01; G06F 3/048

(52) U.S. Cl. 715/704; 715/838

(57) ABSTRACT

A function execution method and a mobile terminal operating with the function execution method are provided for quickly executing a function of an application. The function execution method includes displaying an application screen of an application running in the mobile terminal, capturing the application screen in response to a command, and identifying a function of the application associated with the captured application screen. The method further includes mapping the captured screen to the application and the function, and creating and displaying a macro icon representing the application and the function in the mobile terminal. The mobile terminal may include a control unit and display unit to perform the function execution method.

### CROSS REFERENCE TO RELATED APPLICATION

This application claims priority from and the benefit of Korean Patent Application No. 10-2008-0097347, filed on Oct. 2, 2008, which is hereby incorporated by reference for all purposes as if fully set forth herein.

### BACKGROUND OF THE INVENTION

1. Field of the Invention

Exemplary embodiments of the present invention relate to a function execution method and a mobile terminal operating with the function execution method.

2. Description of the Background

Recently, mobile terminals have evolved to support various supplementary functions including, for example, a text messaging function, camera function, MP3 playback function, electric organizer function, and game function. With diversification of the supplementary functions integrated into the mobile terminal, providing a convenient and easy to use user interface of the mobile terminal has become an important area of research. For example, as the configuration of a user interface becomes increasingly complex with a greater number of supplementary functions, efficient application execution methods are required. To meet this requirement, some applications are mapped to specific keys of a keypad and/or shortcut icons presented on a graphical user interface of the mobile terminal, such that the user can execute the corresponding applications quickly.

In the key mapping method, however, the number of keys composing the keypad may limit the number of applications being mapped. Also, the shortcut icon mapping method may have drawbacks such that the individual shortcut icons may not provide the user with intuitive information on the corresponding applications, and the number of icons may not be enough to map all the applications in a distinctive manner.

### SUMMARY OF THE INVENTION

Exemplary embodiments of the present invention provide a function execution method and a mobile terminal operating with the function execution method to execute functions and/or applications of the mobile terminal efficiently and conveniently.

Exemplary embodiments of the present invention provide a function execution method and a mobile terminal operating with the function execution method to improve function execution capabilities of the mobile terminal by using a captured screen image of the mobile terminal.

Additional features of the invention will be set forth in the description which follows, and in part will be apparent from the description, or may be learned by practice of the invention.

Exemplary embodiments of the present invention disclose a function execution method for a mobile terminal. The method includes displaying an application screen of an application, capturing the application screen in response to a command, identifying a function of the application, mapping the captured application screen to the application and the function of the application, creating a first macro icon corresponding to the captured application screen, and displaying the first macro icon.

Exemplary embodiments of the present invention disclose a mobile terminal including a display unit, a storage unit, and a control unit. The display unit displays at least one macro icon and an application screen of an application. The storage unit stores the at least one macro icon. The control unit captures the application screen in response to a macro icon setting command, and maps the captured application screen to the application and a function associated with the application. The control unit creates a first macro icon representing the application and the function, and instructs the storage unit to store the first macro icon and the captured application screen.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a configuration of a mobile terminal according to exemplary embodiments of the present invention.

FIG. 2 is a diagram illustrating an exemplary application screen displayed on a display of the mobile terminal of FIG. 1, according to exemplary embodiments of the present invention.

FIG. 3 is a flowchart illustrating a function execution method for a mobile terminal according to exemplary embodiments of the present invention.

FIG. 4A, FIG. 4B, and FIG. 4C are diagrams illustrating steps to set a macro icon in the function execution procedure of FIG. 3, according to exemplary embodiments of the present invention.

FIG. 5 is a flowchart illustrating a macro icon-based function execution procedure of the function execution method of FIG. 3, according to exemplary embodiments of the present invention.

FIG. 6A, FIG. 6B, and FIG. 6C are diagrams illustrating steps of the function execution procedure of FIG. 5, according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Detailed descriptions of well-known functions and structures incorporated herein may be omitted to avoid obscuring the subject matter of the present invention.

Prior to explaining exemplary embodiments of the present invention, relevant terminology will be defined for the description below.

An “application” may refer to a software program that is operated by means of a mobile terminal. The application may be, for example, an Internet access application which allows the user to access to the Internet and to communicate data with another terminal via the Internet; a text messaging application which allows the user to write, transmit, and receive text messages; a music file playback application which allows the mobile terminal to play music files stored in a storage unit of the mobile terminal; an organizer application which allows the user to schedule an activity; and/or a memo application which allows the user to write a memo.

An “application screen” may refer to a screen displayed on a display unit of a mobile terminal when a corresponding application is executed.

A “macro function” may refer to a function with which the currently displayed application screen is recorded when a macro icon is set. The macro function may be the function executed when the application screen is captured to set a macro icon. For instance, if an information search function is running when an application screen is captured to set a macro icon while the Internet access application is running, the search function may be a macro function. Also, if a text input function is running when an application screen is captured to set a macro icon while the text messaging application is running, the text input function may be a macro function.

A “macro icon” may refer to a graphical object created by resizing an application screen captured in the mobile terminal. The macro icon may have information on the captured application screen, the application corresponding to the capture application screen, and/or the macro function.

Hereinafter, exemplary embodiments of the present invention are described in detail with reference to the accompanying drawings.

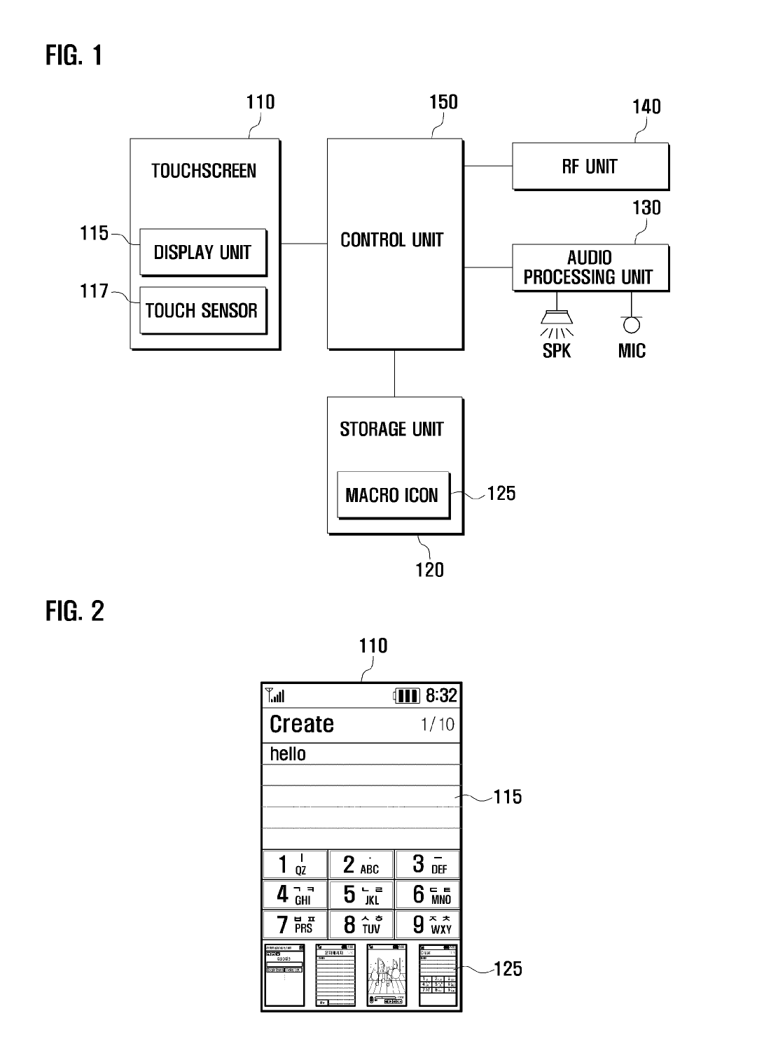

FIG. 1 is a block diagram illustrating a configuration of a mobile terminal according to exemplary embodiments of the present invention. FIG. 2 is a diagram illustrating an exemplary application screen displayed on a display of the mobile terminal of FIG. 1.

As shown in FIG. 1, the mobile terminal may include a touchscreen 110, a storage unit 120, an audio processing unit 130, a Radio Frequency (RF) unit 140, and a control unit 150.

The touchscreen 110 may include a display unit 115 and a touch sensor 117. The display unit 115 may display the operation status and information related to the mobile terminal. For example, the display unit 115 may display the application screen together with macro icons 125 as shown in FIG. 2 under the control of the control unit 150. In the exemplary application screen of FIG. 2, the application screen of the text messaging application may be displayed on the display unit 115 together with at least one macro icon 125. The macro icon 120 can be displayed within a macro icon display window presented in the form of a popup window or an overlay screen floating above the application screen. The screen of display unit 115 may be divided into a first display area for displaying the application screen of the currently running application, and a second display area for displaying a macro icon 125.

The display unit 115 can display a captured screen as an icon in the icon display area and can display visual effects related to the icon under the control of the control unit 150. The display unit 115 can simultaneously display a progress associated with the captured screen. For instance, the captured screen can be iconized into the icon display area with a flipping effect as if a book is flipped. In some cases, the captured screen can be reduced into the size of macro icon 125 in a stepwise manner and then moved to the icon display area.

The display unit 115 may include a touch sensor 117 to sense an input event, which may occur by making and/or releasing a contact on the display unit 115. The touch sensor 117 may extract the coordinates at the position at which the contact is made (e.g., a user's finger or a suitable tool is touched and/or lifted), and may transmit the coordinates to the control unit 150. The control unit 150 can analyze the coordinates transmitted by the touch sensor 117, and may determine whether the touch is a flick, a drag event having a movement direction, or a tap event.

The storage unit 120 may store various applications running in the mobile terminal and application data generated while the applications are running The storage unit 120 may store a macro icon 125. The macro icon 125 may be mapped to the application selected by the user and the macro function may be activated when the application screen has been captured.

The audio processing unit 130 may include a microphone MIC for converting an input sound into an audio signal, and a speaker SPK for outputting an audio signal in the form of an audible sound wave. The audio processing unit 130 may convert the audio signal into audio data.

The RF unit 140 may control radio communications of the mobile terminal with a base station or any other mobile terminal. The RF unit 140 can include a duplexer for separating transmission and reception, a RF transmitter for up-converting and amplifying the transmission signal, and an RF receiver for low noise amplifying and down-converting the received signal. The RF unit 140 may enable the mobile terminal to access, for example, an access network for Internet connection.

The control unit 150 may control operations of the mobile terminal and the mobile terminal's internal function blocks. The control unit 150 may instruct the display unit 115 to display the application screen of the application selected by the user together with the macro icons 125. If a macro icon function is executed, the control unit 150 may capture the current application screen and identify the application and a corresponding function (e.g., application-specific function) activated when the application is captured. The control unit 150 may map the application-specific function and the captured screen, and may store the mapping between the application-specific function and the captured screen in the storage unit 120. In some cases, the application-specific function, the captured screen, and the mapping between the application-specific function and the captured screen can be encoded and then stored in the storage unit 120. The control unit 150 may resize the captured screen into a macro icon and may display the macro icon in the display unit 115. The macro icon 125 may be linked to the corresponding captured screen and may be stored in the storage unit 120.

If a macro icon display option is selected by a menu item or a function key, the control unit 150 may instruct the display unit 115 to display at least one macro icon 125 stored in the storage unit 120. The macro icons can be displayed within a macro icon display window provided as a popup window or an overlay window floating above the application screen. A screen of the display unit 115 may be divided into two display areas: one for displaying the current application window and the other for displaying the macro icons 125. If a zoom-in option is selected by a menu item or a function key designated for zooming in on a macro icon, the control unit 150 may instruct the display unit 115 to zoom in on the selected icon.

If a macro icon 125 is selected by the user, the control unit 150 may link the application screen and macro function to the macro icon 125 on the display unit 115. Accordingly, the application screen and the function designated as the macro function may be recovered at a time when the application screen is captured for setting the macro icon 125.

Although not shown, the mobile terminal can include other function blocks such as a camera unit for taking pictures and a Digital Multimedia Broadcast (DMB) unit for transmitting and receiving digital broadcast signals. The mobile terminal may also include a motion sensing unit for sensing the motion of the mobile terminal, such as, for example, a rotation movement. The motion sensing unit can include a gyroscope or an acceleration sensor.

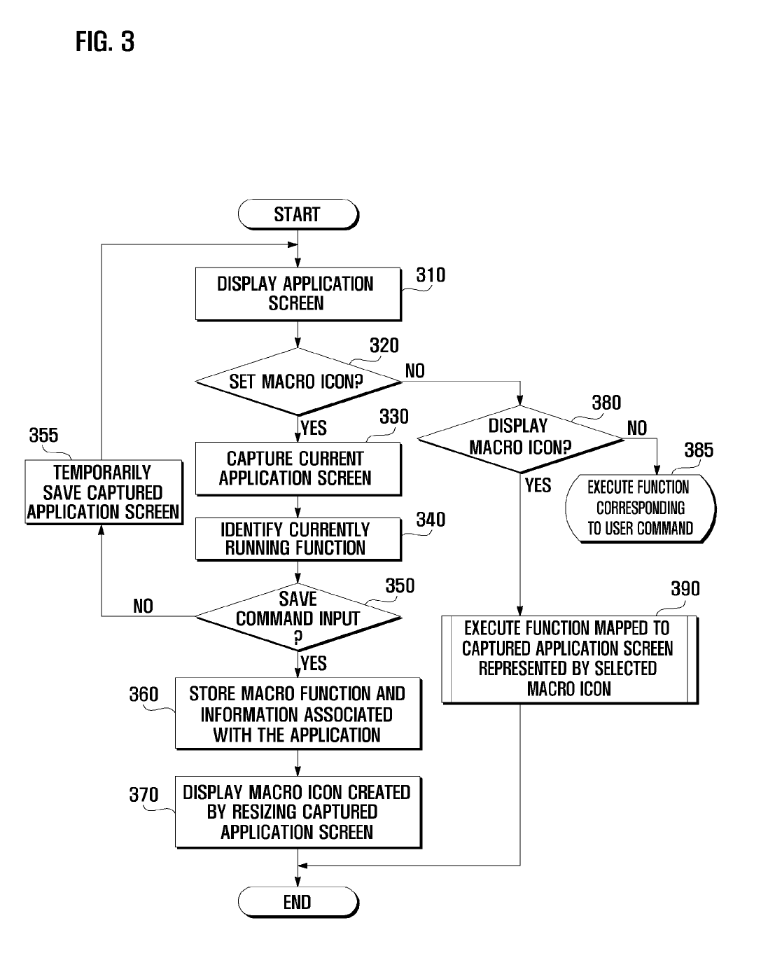

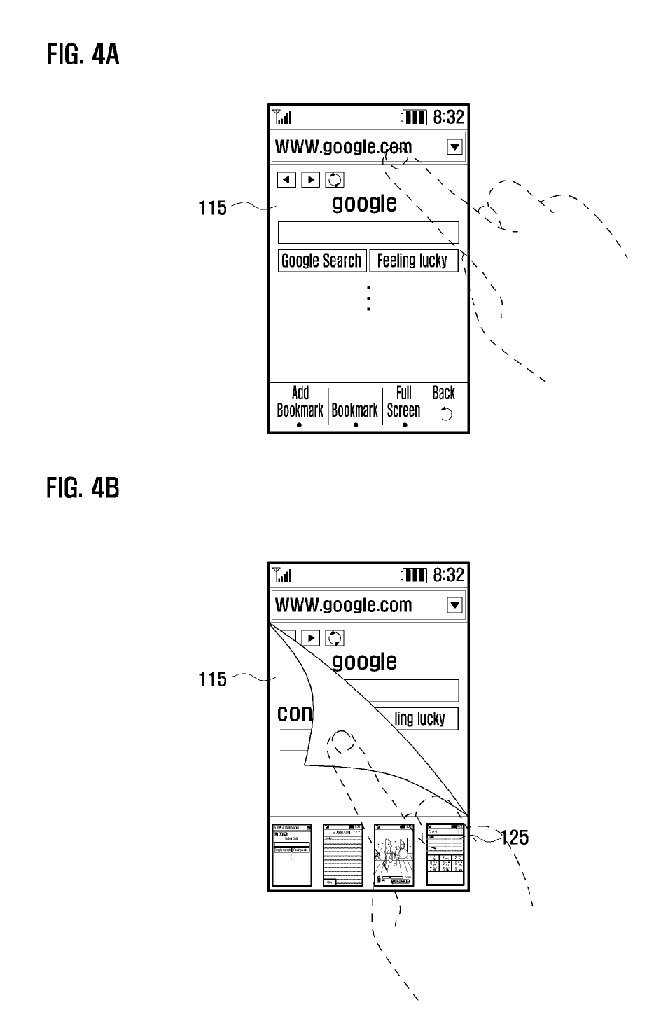

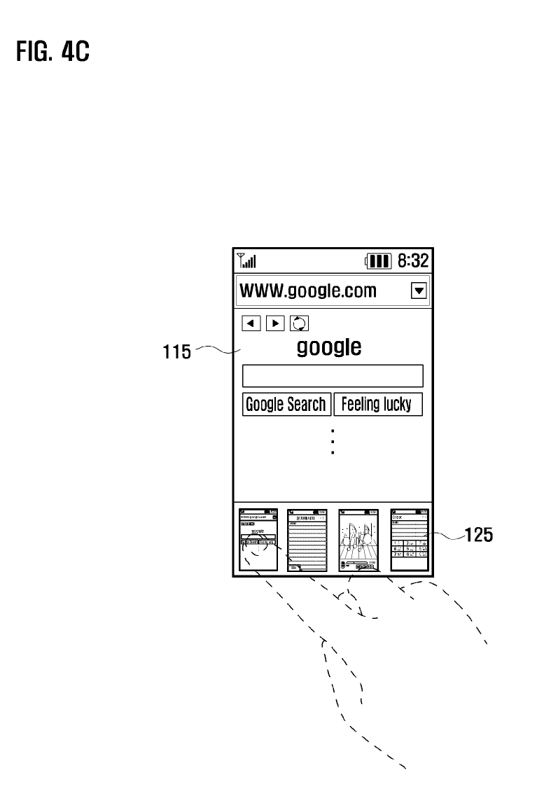

FIG. 3 is a flowchart illustrating a function execution method for a mobile terminal according to exemplary embodiments of the present invention. FIG. 4A, FIG. 4B, and FIG. 4C are diagrams illustrating steps of setting a macro icon in the function execution procedure of FIG. 3.

Referring to FIG. 3, FIG. 4A, FIG. 4B, and FIG. 4C, if an application is executed by the user selecting a menu item or a function key designated for executing the application, the mobile terminal may enter an application-specific operation mode and may display an application screen corresponding to the application. If an application-specific function is selected using a menu item or a function key designated for the function while the mobile terminal is running in the application-specific operation mode, the control unit 150 may display a function execution window corresponding to the selected application-specific function on the application screen (310). For instance, if an internet access application is executed by the user, the mobile terminal may enter the Internet access mode. If a search function is selected by the user, the mobile terminal may access a search website and may display the webpage provided by the website on the display unit 115.

While the function execution window is displayed, the control unit 150 may detect a user command and may determine whether the command is a command to set a macro icon (320). The macro icon setting command can be input by the user selecting a menu item or a function key designated as the macro icon setting command. In some cases, the macro icon setting command can be input by an event (e.g., a touch event) at a position on the touchscreen 110 that is mapped to the macro icon setting command by the user or by a designer/manufacturer of the mobile terminal. If the user touches the position at which the macro icon setting command is mapped by using, for example, a finger or a stylus pen, the control unit 150 may identify the macro icon setting command mapped to the position at which the touch event is detected, and may execute the macro icon setting command.

If the user command is a macro icon setting command at step 320, the control unit 150 may capture the application screen on which the application-specific function window is displayed (330). FIG. 4A is an example of a screen image displayed when the mobile terminal is connected to a website. The user may contact a position mapped to the macro icon setting command on the touch screen 110 by using a finger or a stylus and may then release the contact. The control unit 150 may identify the macro icon setting command mapped to the position and may capture the currently displayed application screen.

After capturing the application screen, the control unit 150 may check and identify the application and the application-specific function associated with the captured application screen (340). For instance, if the user types a keyword in the search text box provided on the webpage and enters the search command, the control unit 115 may generate a search result page and present the search result page in the application screen displayed on the display unit 115. If the macro icon setting command is input while the search result page is displayed, the control unit 150 may capture the application screen presenting the search result page and may check the Internet access application and identify the search function as a macro function.

For example, if the running application is a text messaging application, as shown in FIG. 2, the control unit 150 may display the text messaging application screen on the display unit 115. When the user types a text message in the message composition window, the control unit 150 may execute a text message composition function with the presentation of the typed text. If the macro icon setting command is input while the text message composition function is running, the control unit 150 may capture the application screen having the text message composition window with the typed text.

After checking the application and the application-specific function associated with the captured application screen at step 340, the control unit 150 may determine whether a save command is input (350). If no save command is input for a predetermined time period, the control unit 150 may temporarily save the captured application screen and return to step 310.

If a save command is input, the control unit 150 may map the application and the macro function to the captured application screen, and may store the information (e.g., captured application screen) associated with the application and macro function in the storage unit 120 together with the mapping information (360). The save command can be input by the user selecting a menu item or a function key designated for the save command. The save command may also be input by a specific touch event. For instance, if a drag event is detected on the touchscreen 110 after the application screen is captured as shown in FIG. 4B, the control unit 150 may regard the drag event following the application screen capture as an input of the save command. That is, if the user drags and drops the captured application screen into the macro icon display area on the touchscreen 110, the control unit 150 may regard the drag and drop event as an input for a save command. The captured application may be iconized into the macro icon display area with, for example, a flipping effect, like flipping a book page, as shown in FIG. 4B. The captured application screen may be reduced to a predetermined size of the macro icon in a stepwise manner and then moved to the macro icon display area. In some cases, the captured application screen may be displayed within a popup window or an overlay window floating above the application screen.

Next, the control unit 150 may resize the captured application screen into a macro icon 125 and may display the macro icon 125 (370). The macro icon 125 may be displayed in a popup window or an overlay window floating above the application screen or in the macro icon display. The control unit 150 may divide the screen of the display unit 115 into the application display area and the macro icon display area such that the application screen and the macro icons are displayed simultaneously within corresponding display areas as shown in FIG. 4C.

Returning to step 320, if it is determined that the user command is not the macro icon setting command, the control unit 150 may determine whether the user command is a command to display a macro icon (380). If the user command is not the macro icon display command, the control unit 150 may execute a function corresponding to the user command (385). Examples of the user command include a text input command, a text message transmission command, and/or a music file play command.

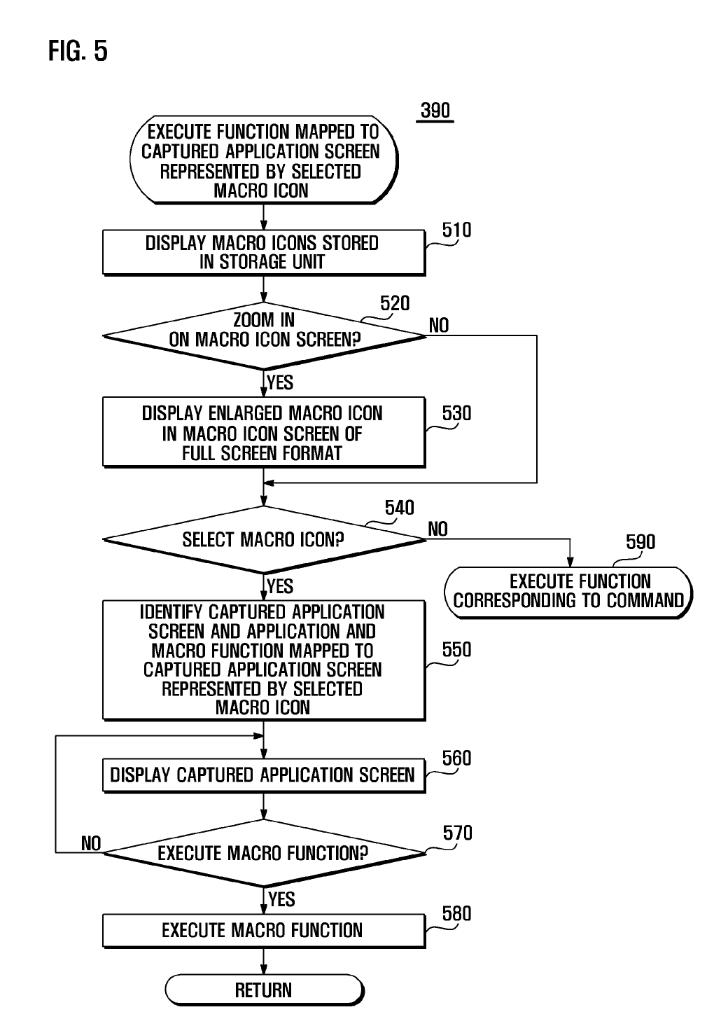

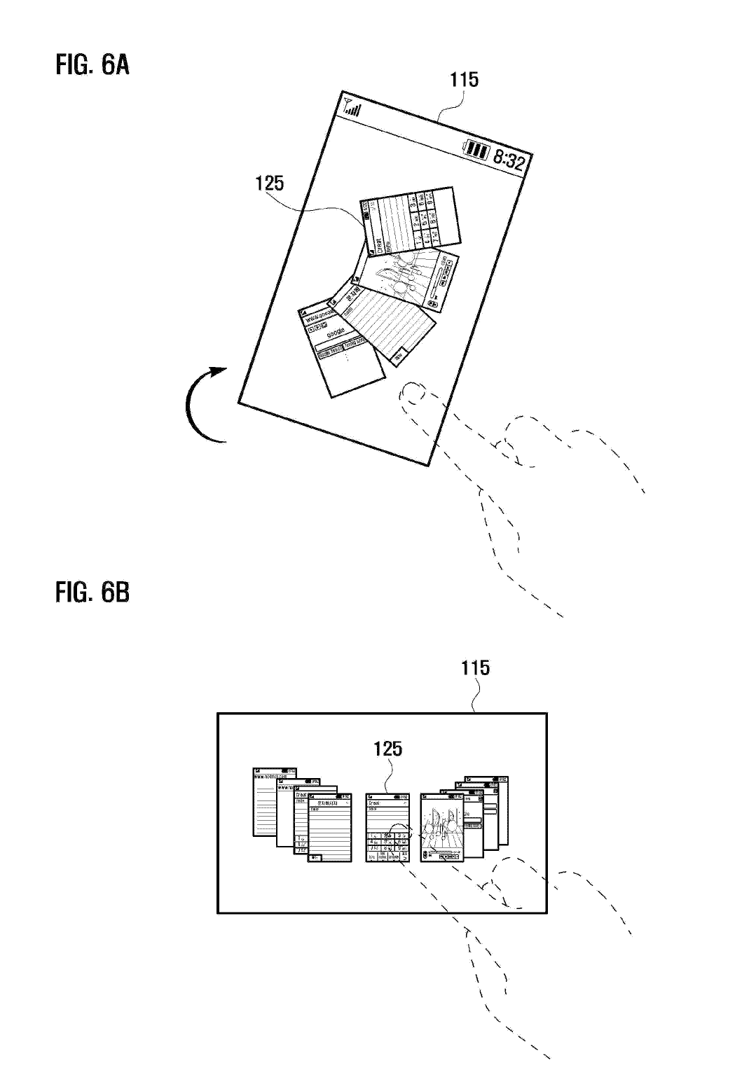

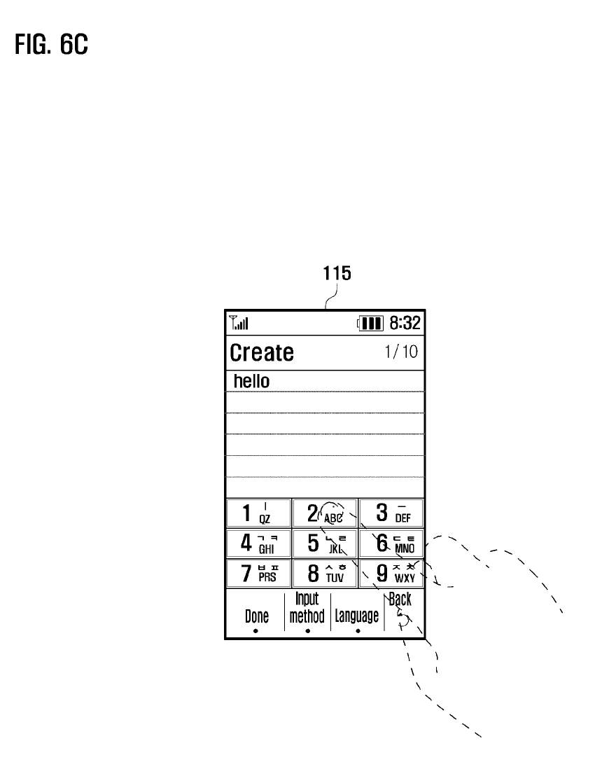

If the user command is the macro icon display command at step 380, the control unit 150 may display the macro icons and, if a macro icon is selected, may execute the function mapped to the captured application screen represented by the selected macro icon (390). The function execution procedure is described in more detail with reference to FIG. 5, FIG. 6A, FIG. 6B, and FIG. 6C.

FIG. 5 is a flowchart illustrating a macro icon-based function execution procedure of the function execution method of FIG. 3. FIG. 6A, FIG. 6B, and FIG. 6C are diagrams illustrating steps of the function execution procedure of FIG. 5.

Referring to FIG. 5, FIG. 6A, FIG. 6B, and FIG. 6C, once the macro icon display command is input as described above with reference to step 390 of FIG. 3, the control unit 150 may call the macro icons stored in the storage unit 120 and may instruct the display unit 115 to display the macro icons (510). The macro icons can be displayed within a macro icon display window presented in the form of a popup window or an overlay window floating above the application screen. If the screen of the display unit 115 is divided into an application display screen and a macro icon display screen, the macro icons may be displayed in the macro icon display screen while an application screen may be displayed in the application display screen.

After displaying the macro icons, the control unit 150 may detect a user command input by the user and may determine whether the user command input is a zoom-in command (520). If the user command is not a zoom-in command, the control unit 150 may determine whether the user command is a macro icon selection command (540), as explained in further detail below.

If the user command is the zoom-in command, the control unit 150 may zoom in on the macro icon display screen and may display enlarged macro icons in a full screen format as shown in FIG. 6A (530). The zoom-in command can be input by the user selecting a menu item or a function key designated as the zoom-in command. The zoom-in command can also be input by an event (e.g., a posture rotation event detected by a motion sensing unit when the mobile terminal is rotated). The control unit 150 may designate a rotation event occurring following the display of the macro icons as an input of the zoom-in command, and may thus display the macro icon display screen as a full screen image with enlarged macro icons. As illustrated in FIG. 6A, if the mobile terminal moves in a rotational manner such that the posture of the screen is changed from a portrait posture to a landscape posture, the control unit 150 may sense the rotation by means of the motion sensing unit and may change the macro icon display screen displayed in the form of a popup window or an overlay window into a full screen image having enlarged macro icons. In some cases, the enlarged macro icons 125 can be arranged in a circular pattern as shown in FIG. 6B or a linear pattern. In such cases, the application screen may disappear or appear vaguely as a background image.

After displaying the macro icon display screen in the form of a full screen image, the control unit 150 may detect a user command input by the user and may determine whether the user command is a macro icon selection command (540). If the user command is a macro icon selection command, the control unit 150 may retrieve the captured application screen represented by the selected macro icon, and the application and macro function mapped to the captured application screen (550). Next, the mobile terminal may activate the application-specific operation and may display the captured application screen on the display unit 115 (560). The control unit 150 may then determine whether a macro function execution command is input (570). If the macro function execution command is input, the control unit 150 may execute the macro function mapped to the captured execution screen represented by the macro icon (580). If the macro function execution command is not input, the control unit 150 may return to step 560 and may continue to display the captured application screen on the display unit 115.

If the macro icons 125 are arranged in a circular pattern as shown in FIG. 6B, whenever a drag event for selecting one of the macro icons 125 is detected on the touchscreen 110, the control unit 150 may display the selected icon in the middle of the display unit 115. If a tab event is detected on the touchscreen 110 for selecting a macro icon 125, the control unit 150 may identify the macro icon 125 placed at the position on which the tab event is detected. When the selected macro icon is identified, the control unit 150 may execute the identified application and may instruct the display unit 115 to display the captured application screen on which the application-specific function is activated. For example, if, as shown in FIG. 6B and FIG. 6C, the selected macro icon 125 represents a captured application screen of a text messaging application having a text input function, the control unit 150 may activate the text messaging application and may execute the message execution function. Next, the control unit 150 may display the captured application screen on the display unit 115 and may recover the text input instance recorded when the application screen had been stored. For example, the text “Hello” may be entered in a text input window at the time when the macro icon setting function is executed. When the text input function is recovered, the cursor is placed right after the text “Hello,” and thus the control unit 150 may enter the next character input through the touchscreen 110. Accordingly, when a macro icon 125 representing a captured application screen of an application having a running function is selected, the control unit 150 can recover the operation instance of the application (that had been recorded when the macro icon setting function was executed) without closing the currently running application.

Returning to step 540, if the user command is not a macro icon selection command, the control unit 150 may execute a function corresponding to the user command (590). For instance, based on the user command, the control unit 150 may instruct the display unit 115 to display the original size of the macro icon display window. For example, if the posture of the screen is changed from the landscape posture to the portrait posture, the control unit 150 may sense the rotation by means of the motion sensing unit and may change the full screen macro icon display window into the normal macro icon display window. The recovered normal macro icon display window can be displayed in the form of a popup window or an overlay window.

If the user command is a macro icon delete command, the control unit 150 may identify the macro icons indicated by the macro icon delete command and may delete the selected macro icon. The macro icon delete command can be used to delete a selected macro icon or all the macro icons displayed in the macro icon display window.

Referring back to FIG. 5, FIG. 6A, FIG. 6B, and FIG. 6C, if a macro icon is selected while an application is running in the mobile terminal, the application mapped to the captured application screen represented by the selected macro icon may be activated with the function that has been running when the macro icon setting command is executed. However, exemplary embodiments of the present invention are not limited thereto. For instance, the mobile terminal can be configured such that a macro icon display command can be input by the user selecting a menu item or a function key in the idle mode screen. The control unit 150 can detect the macro icon display command to call the macro icons stored in the display unit 120, and may display the macro icons on the display unit 115. The macro icons can be displayed in the form of a popup window or an overlay window floating above the idle mode screen. Also, the macro icons can be arranged in various patterns, such as, for example, a linearly arranged pattern, according to the user settings. If a specific macro icon is selected by the user, the control unit 150 may execute a function mapped to the captured execution screen represented by the selected icon 125.

In the above described exemplary embodiments, the macro icons 125 maybe displayed on the touchscreen-enabled display unit and selected by a touch event on the touchscreen 110. However, exemplary embodiments of the present invention are not limited thereto. For instance, the function execution method can be applied to the mobile terminal operating with a keypad, such that the macro icons can be executed or set by the user by selecting a menu item or by manipulating function keys, such as a navigation keys.

As described above, the function execution method and mobile terminal operating with the function execution method may advantageously perform quick executions of a specific function of an application.

Also, the function execution method and mobile terminal operating with the function execution method may enable a user of the mobile terminal to intuitively identify an application represented by an icon.

Also, the function execution method and mobile terminal operating with the function execution method may enable recording an instance of an application screen on which a specific function is running and recovering the instance afterward. Accordingly, a user may quickly restart a task that may have been stopped to execute a function without closing a currently running application.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A function execution method for a mobile terminal, the method comprising:
displaying an application screen of an application;
capturing the application screen in response to a command;
identifying a function of the application;
mapping the captured application screen to the application and the function of the application;
creating a first macro icon corresponding to the captured application screen; and
displaying the first macro icon.

2. The function execution method of claim 1, further comprising:
displaying a macro icon window having at least one macro icon in response to a macro icon display command;
retrieving, in response to selection of the first macro icon, the application and the function being represented by the selected first macro icon;
displaying the captured application screen; and
executing the function.

3. The function execution method of claim 2, wherein displaying a macro icon window comprises:
determining whether a zoom-in command is input; and
enlarging, in response to the input zoom-in command, the macro icon window into a full screen window with the at least one macro icon being enlarged.

4. The function execution method of claim 3, wherein enlarging the macro icon window comprises arranging the at least one macro icon in a circular pattern or a linear pattern.

5. The function execution method of claim 1, wherein the application comprises one of an Internet access application, a text messaging application, an organizer application, and a music file playback application.

6. A mobile terminal, comprising:
a display unit to display at least one macro icon and an application screen of an application;
a storage unit to store the at least one macro icon; and
a control unit to capture the application screen in response to a macro icon setting command, to map the captured application screen to the application and a function associated with the application, to create a first macro icon representing the application and the function, and to instruct the storage unit to store the first macro icon and the captured application screen.

7. The mobile terminal of claim 6, wherein the display unit displays, in response to a macro icon display command, a macro icon window having the at least one macro icon and the display unit displays the captured application screen, and wherein the control unit retrieves, in response to a selection of the first macro icon, the application and the function.

8. The mobile terminal of claim 7, wherein the control unit enlarges, in response to a zoom-in command, the macro icon window into a full screen window with the at least one macro icon being enlarged.

9. The mobile terminal of claim 8, wherein the control unit arranges the at least one macro icon in a circular pattern or a linear pattern.

10. The mobile terminal of claim 6, wherein the application comprises one of an Internet access application, a text messaging application, an organizer application, and a music file playback application.

11. The mobile terminal of claim 6, wherein the control unit creates the first macro icon by resizing the captured application screen.

12. The function execution method of claim 1, wherein displaying an application screen of an application comprises running the application in the mobile terminal.

13. The function execution method of claim 1, wherein creating a first macro icon comprises creating a first macro icon by resizing the captured application screen to a smaller captured application screen.

14. The mobile terminal of claim 6, wherein the application runs in the mobile terminal.

15. A function execution method for a mobile terminal, the method comprising:
displaying an application screen of an application;
capturing the application screen;
mapping the captured application screen to the application and a function of the application; and
displaying a first macro icon corresponding to the captured application screen.

16. The method of claim 15, further comprising:
storing the first macro icon; and
retrieving the function and the application in response to selecting the first macro icon.

17. The method of claim 15, further comprising:
receiving a macro icon display command;
displaying a macro icon window in response to the macro icon display command;
receiving an input zoom-in command; and
enlarging, in response to the zoom-in command, the macro icon window into a full screen window comprising at least one macro icon.
